(19) United States
(12) Patent Application Publication
(10) Pub. No.: US 2024/0161030 A1
(43) Pub. Date: May 16, 2024

(54) Back Up Care

(71) Applicant: George Koenig, Mendham, NJ (US)

(72) Inventor: George Koenig, Mendham, NJ (US)

(21) Appl. No.: 18/170,103

(22) Filed: Feb. 16, 2023

Related U.S. Application Data
(60) Provisional application No. 63/317,108, filed on Mar. 7, 2022.

(51) Int. Cl. G06Q 10/0631

(52) U.S. Cl. CPC G06Q 10/063116

(57) ABSTRACT

Back Up Care, a process or method, involves pre planning of an individual worker to ensure a scheduled shift is completed, when such worker cannot fulfill a scheduled shift. They can enact Back Up Care which ties a network of other like-minded individuals and a client who needs a job performed together.

Use

Back Up Care is used by three parties in each situation, including the primary worker, the designated Back Up Care worker, and the client who requires service. The flow, as described in claim 1 under Section D Claim Body, is utilized electronically through an online platform.

Advantage

Back Up Care is a fully electronic closed loop solution between all three parties. Back Up Care is a significant improvement to any type of staffing company or individual through an Internet enabled platform as any application would involve staffing and the need for backup staffing.

The application for this patent is initially for Backup Care associated with Home Health Care Staffing yet it can be applied to many industry and segment uses. For now let's focus on Backup Care for a company that provinces care directly or indirectly through a platform such that when a Care Provider for whatever reason is unable to go to work for their assigned times they can PRE PLAN to have their shift covered by recommending their friends, family, or others they suggest as capable of fulfilling their shift. Secondly, in some cases as we will initially use our software process for is that the suggested fill in or backups by the primary caregiver become associated with them and their client and whoever is engaging them such as an individual or a company. When they inform such an individual or company they can't make their designated work times then the client and “backup care Providers” are notified immediately via texts and email. As such, the client may engage any or all of the designated back up care providers who have the opportunity to pick up the shift by selecting yes to the notification they receive that a shift is open to include basic information such as location of shift, client, client needs, pay rate etc.

Should they accept yes and since the client has initiated the back up care process then the system updates the shift and the client and client designated site users like additional family members receive a text and email that the original care provider called out and the backup will fill in and such notification will include information on the care provider such as name, skill set, their rating by other clients and that the client accepted them as a potential backup based on the primary care providers recommendation of which they could accept or deny at time they are recommended.

Preplanning for backup caregivers entails creating a site profile with their information and skill set and the optional background check if requested by the client. Once the backup caregiver accepts the “backup” invite and has completed the optional background check, they can begin to fill those shifts as needed.

This closed loop solution is a significant improvement to any type of staffing company or individual through an internet enabled platform as any application would involve staffing and the need for back up staffing.

Client and care provider create profiles

Care provider can add invites to join site to other care providers they feel can benefit from the site by joining and are designated after joining as being a backup care provider to the care provider who invited them into the platform.

When any assigned care provider engaged by client can't make a shif they client and family are informed electronically and they can pick any or all of the backup providers to fill the open shift

Then whoever picks up the open shift first is assigned to it and the family, client, and other designated users are electronically informed of the new backup care provider being assigned.
Client searches and finds a care provider they like and asks for interview
An interview is completed and if both parties are in agreement the client initiates

Client and Care Provider create profiles.

Care Provider is able to invite other Care Providers that would benefit from the site and thereafter, the invitee would become a designated Backup Care Provider to the Care Provider who invited them into the platform.

When any assigned Care Provider engaged by the client electronically declines the shift by text or email, then the client (including all members who have signed up to receive notifications) is informed electronically by text/emails.

Then, the client selects any or all of the Backup providers to fill the open shift. Text and emails are sent to those Backups.

The first Backup Care Provider to accept the open shift is assigned to that shift and then client, family, and other registered users are electronically informed (text and email) of the new Backup Care Provider.

The client may run an optional background check on any Care Provider and Backup Care Provider once given authorization.

Backup Care Provider clocks in at client's house via Global Position Software, completes said shift, and is automatically paid by the client 72 hours after the shift. Payment is sent directly into the Care Provider's designated account.

A) Independent Claim 1

Back Up Care is a process within an online platform in which a primary worker has the ability to proactively suggest other coworkers to fill their shifts, in any industry or segment, when the primary worker cannot complete scheduled work.

B) Preamble

Back up Care, an intangible yet definable software process corresponding to claim 1, is a series of events beginning with a worker adding trusted colleagues, friends, and other professional contacts to join their Back Up Network and ends with an individual from said Back Up Network fulfilling a shift that the primary worker cannot make. Workers that utilize a platform that engages both the worker and the client, of any industry, send colleagues, friends, and other professional contacts an electronic invitation to join their Back Up Network through email. The email contains a link for the invitee to enter first and last name, phone number, and email address. This information is now stored under the inviter-worker's profile within the online platform and is visible to clients so that there is significant staffing improvement to any type of staffing company or individual when the primary worker cannot fill a scheduled shift.

C) Transitional Phase

Back Up, an intangible yet definable process, is initially designed for home health care staffing but is not limited to this setting. It can be applied to any industry and segment uses that schedule workers. The patent application example refers to a Home Health Care setting, involving a client and a care provider. This invention, corresponding to claim 1, is not limited to Home Health Care.

D) Claim Body

The invention, corresponding to claim 1, was invented by George Koenig to expedite staffing-issue solutions for work that needs to be fulfilled. Back Up structure is below:

1. A worker, who has already created a profile on an online, or any other platform as a registered user, invites other workers to become a team of designated back-up workers through a link sent by email or by phone.

2. Invited-worker may accept or decline the invitation. If they decline, no further action takes place or is required. If they accept, they will click the link and enter first and last name, phone number, and email address. This information is stored within the online platform, under the primary worker's profile. Herein, the invited-worker's information is visible to all clients on the platform, should the client need a shift to be fulfilled that the primary worker cannot make.

3. Client schedules the primary worker for a shift. This worker is sent a 24 hour text/email notification prior to the start of the shift, as well as a 2 hour text/email notification prior to the start of the shift. If the worker confirms the shift, no further action is required. If the worker declines the shift, at either notification timeframes, Back Up Care, corresponding to claim 1, process begins.

4. Client is instantly notified by a text/email, and possibly by phone call, notification that the primary worker is unable to fulfill the scheduled shift. Through the online platform, the client may select any or all Back Up workers under the primary worker's Back Up Care Network to offer the shift. By selecting individuals in the Back Up Care Network, the client is electronically sending instant text/email/phone call notifications to each individual that was selected that there is a shift available.

5. The first Back Up worker to accept the open shift is assigned to that shift instantly. Such Back Up worker will receive scheduling information such as who, when, where, and what duties are involved and then will receive the 24 hour/2 hour pre-shift reminder notifications.

6. The client receives a text/email notification informing them that said Back Up worker has accepted said shift.

7. Back Up worker then follows the clock in/out process as if they were the primary worker and are paid for their work, as they replaced the primary worker for such scheduled work.
